(19) United States
(12) Patent Application Publication
(10) Pub. No.: US 2009/0274603 A1
(43) Pub. Date: Nov. 5, 2009

(54) NON-AQUEOUS EXTRACTION OF [18F] FLUORIDE FROM CYCLOTRON TARGETS

(76) Inventors: Colin Steel, London (GB); Sajinder Luthra, London (GB); Frank Brady, London (GB)

Correspondence Address: GE HEALTHCARE, INC., IP DEPARTMENT 101 CARNEGIE CENTER, PRINCETON, NJ, 08540-6231, US

(21) Appl. No.: 12/515,326

(22) PCT Filed: Dec. 5, 2007
(86) PCT No.: PCT/US07/86435

§ 371 Date: May 18, 2009

(30) Foreign Application Priority Data
Dec. 6, 2006 (US) 60/868737

(51) Int. Cl. C01B 7/20; G21G 1/10

(52) U.S. Cl. 423/249; 376/195

(57) ABSTRACT

The present invention provides a method and an apparatus for extracting an isotope from a gas. More specifically, the present invention depicts a system that has been devised which provides [¹⁸F] fluoride from a cyclotron target in non-aqueous media.

### FIELD OF THE INVENTION

The present invention relates to the field of isotope recovery from cyclotron target systems. More specifically, the present invention relates to a method, apparatus, a method of use for, and a use of a non-aqueous extraction of [¹⁸F] fluoride from a cyclotron target system.

### BACKGROUND OF THE INVENTION

Electrophilic ¹⁸F in the form of [¹⁸F]F2 has long been important in the production of radiopharmaceuticals for positron emission tomography (“PET”). Although it is easier to make nucleophilic aqueous [¹⁸F]fluoride from the bombardment of [¹⁸O] H2O with protons, [¹⁸F]F2 is still used in the investigation of new radiochemistry requiring electrophilic substitution, and clinically, e.g. in the synthesis of L-6-[¹⁸F]fluoro-DOPA. Firnau et al., 1984.

Furthermore, the expansion of clinical PET is still limited by the availability of PET tracers, principally ¹⁸F-FDG. Regional distribution using present production technology has its limits. Ultra high yields from an ¹⁸O(p,n) ¹⁸F reaction using high beam current irradiations holds the most promise for fulfilling the requirements for large area distribution.

In order to achieve high yields of ¹⁸F-fluoride, the best available nuclear reaction is the ¹⁸O(p,n) ¹⁸F, Ruth and Wolf, 1979, Radiochim. Acta, vol. 26, pgs. 21-24, reaction using protons with an energy up to about 20 MeV. While water targets have been operated at ever increasing beam currents they have not been reliably operated above 50 microAmps. In addition, the recovery of the enriched water presents some difficulties including the loss of enrichment.

The steps involved in producing high yields of ¹⁸F include the production via ¹⁸O(p,n) ¹⁸F reaction using a gas target, recovery of the enriched ¹⁸O2 target gas, target washing with water followed by trapping ¹⁸F— on an ion column, fluoride ion elution for chemistry with standard solutions, and target drying for the next run. Each of these steps has been demonstrated in a number of different target systems including ¹⁸F-fluorine (F2) production but they have not been applied in combination to the production of ¹⁸F-fluoride from a gas target.

It is important to point out that [¹⁸F]Fluoride is typically prepared by proton bombardment of ¹⁸O-enriched water. However, due to the limited supply of enriched water, consideration has been given to the use of ¹⁸O₂ gas to prepare ¹⁸F fluoride. For example, see Ruth T. J. et al in Appl. Radiat. Isot. 55, 457 (2001), the entire disclosure of which is hereby incorporated by reference herein as if fully disclosed herein. Gas targets are more advantageous than liquid targets as gas targets are mechanically simpler and capable of being operated at high beam currents.

After bombardment, ¹⁸O₂ gas is recovered from the target for use in subsequent irradiations. See Roberts A. D. et al. in Appl. Radiat. Isot., 46, 87 (1995). Its entire disclosure of which is hereby incorporated by reference herein as if fully disclosed herein. [¹⁸F] fluoride is then extracted from the target using steam. However, if the extraction conditions are not carefully controlled, the volume of liquid containing [¹⁸F] fluoride can be excessive which thereby limits the practical application of the target. Moreover, due to the use of steam, the target must also be thoroughly dried before being re-used.

There is therefore a need in the art for a more effective and efficient method for extracting the [¹⁸F] fluoride from a gas target.

### SUMMARY OF THE INVENTION

The present invention provides a method, apparatus, a method of use for, and a use of extracting an isotope from a gas. More specifically, the present invention depicts a system that has been devised which provides [¹⁸F] fluoride from a cyclotron target in non-aqueous media. The method utilizes the ¹⁸O(p,n) ¹⁸F reaction whereby ¹⁸O2 gas is bombarded with protons. After recovery of the O₂ gas from the target, the system allows a non-aqueous solvent such as acetonitrile to enter the target chamber. An ultrasonic transducer, which is incorporated into the target, is then used to re-suspend the [¹⁸F] fluoride into the non-aqueous solvent. The [¹⁸F] fluoride solution is then transferred to a desired location. Residual solvent is flushed from the target prior to further [¹⁸F] fluoride productions. Subsequent chemical processing is improved since removal of a solvent such as acetonitrile is easier to achieve using an automated system when compared to the removal of water from aqueous [¹⁸F] fluoride solutions. A schematic diagram of the cyclotron target system is given in FIG. 1. FIG. 2 presents a detailed sketch of the gas target chamber and FIG. 3 depicts a diagram of the full process of extracting an isotope from a cyclotron target of the present invention and.

It is important to point out that the term ultrasonically defined herein is having a frequency above the human ear's audibility limit of about 20,000 hertz.

Furthermore, the present invention depicts several advantages over prior inventions. Unlike other extraction methods, the present invention uses the extraction of [¹⁸F] fluoride in a solvent that is more amenable to automated radiochemistry than disclosed in the prior art. The present invention also provides easier solvent removal from the target body prior to subsequent irradiation.

An embodiment of the present invention claims a method for extracting an isotope from a cyclotron target by bombarding an amount of ¹⁸O₂ gas with protons within a gas target to separate an isotope then recovering the ¹⁸O₂ gas from the gas target then next delivering a non-aqueous solvent into the gas target followed by forming a suspension of said isotope of interest within said non-aqueous solvent wherein the gas target is further followed by transferring said suspension from said gas target to a second location and then removing the solvent from said suspension at said second location.

A further embodiment of the present invention includes a gas target for extracting an isotope from a gas wherein the gas target comprises a temperature sensitive target chamber material, an ultrasonic transducer, and a target chamber.

### BRIEF DESCRIPTION OF THE DRAWINGS

FIG. 1 depicts a schematic of the cyclotron target non-aqueous solvent extraction system of the present invention.

FIG. 2 depicts a detailed sketch of the gas target chamber.

FIG. 3 shows a schematic of the full process of extracting an isotope from a cyclotron target.

### DETAILED DESCRIPTION OF THE INVENTION

A method for the extraction of an isotope from a cyclotron target is described herein. Proof-of-principle experiments demonstrate that it is possible to design and build a gas target chamber that can be used routinely to produce terabecquerel (curie) quantities of an isotope when operated below 100 microAngstroms.

The steps of one of the embodiments of the present invention involved in producing a method of extraction of an isotope from a cyclotron target comprises:
a) Bombarding an amount of ¹⁸O₂ gas with protons within a gas target to separate an isotope;
b) Recovering the ¹⁸O₂ gas from the gas target;
c) Delivering a non-aqueous solvent into the gas target;
d) Forming a suspension of said isotope within said non-aqueous solvent within the gas target;
e) Transferring said suspension from said gas target to a second location; and
f) Removing the solvent from said suspension at said second location.

Each of these steps has been demonstrated in a number of different target system productions but they have not been applied in combination to the production of an isotope from a gas target. Accordingly, the method of extraction of an isotope from a cyclotron target as well as the experimental proof that such a target system can be built and operated to generate large quantities of isotopes are described herein.

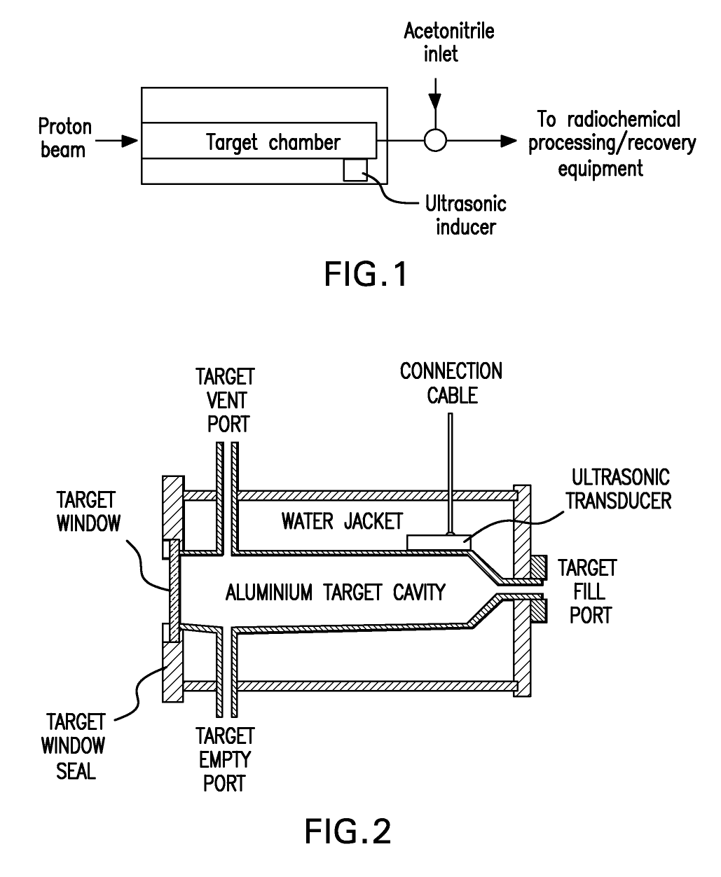

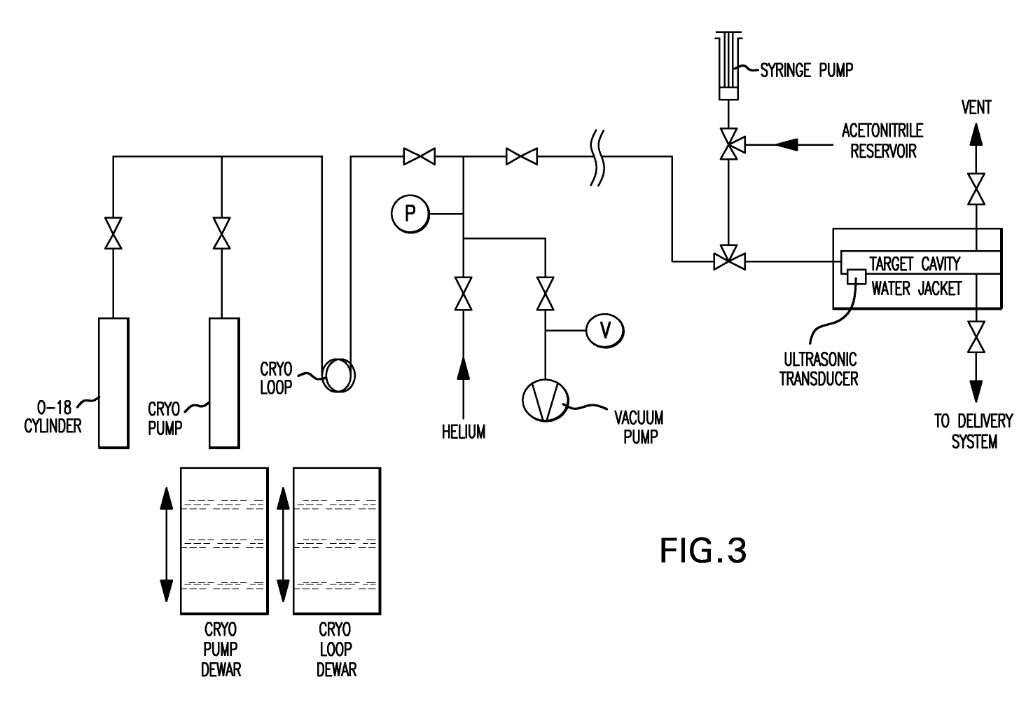

All experiments herein described were performed using a target chamber material of either nickel-plated aluminum, stainless steel, aluminum, glassy carbon, titanium, platinum, silver, or anodized aluminum. The gas target has a water cooling jacket attached to the target chamber. A schematic diagram of the target system can be seen in FIG. 1 and a schematic of the target chamber in FIG. 2.

The following parameters were tested to demonstrate the potential for the successful operation of a gas target to produce an isotope such as ¹⁸F. The target chamber material and windows and pressure/chamber size were viewed as well as the recovery of target gas. The efficiency of washing the target including temperature sensitivity was also viewed as was the recovery of the isotope from enriched water or ¹⁸O₂ gas.

One embodiment of the present invention encompasses an isotope that is ¹⁸F.

Another embodiment of the invention depicts a non-aqueous solvent such as acetonitrile, DMSO or DMF.

Yet a further embodiment of the invention encompasses forming a step further that comprises a step of suspending said isotope into the non-aqueous solvent using an ultrasonic transducer.

Still a further embodiment of the invention depicts that the ultrasonic transducer is located within said gas target. Yet a further embodiment encompasses the step of flushing residual solvent from said gas target.

Yet another embodiment of the present invention presents an amount of ¹⁸O₂ gas with protons within a gas target cavity wherein the gas target chamber is filed to a pressure of about 1898 kPa.

A further embodiment of the present invention includes a gas target for extracting an isotope from a gas wherein the gas target comprises a temperature sensitive target chamber material, an ultrasonic transducer, a target chamber cavity, a target vent port, a target empty port, a connection cable attaching the ultrasonic transducer to a delivery system, a water jacket, and a target fill port. The delivery system herein is the radiochemical processing/recovery equipment.

Yet another embodiment of the present invention depicts the water jacket in the gas target is used to keep the gas target from overheating and the target fill port is the port where the non-aqueous solvent is administered. The non-aqeuous solvent to be used is acetonitrile, DMSO, or DMF.

Another embodiment of the present invention is wherein the chamber material is nickel-plated aluminum, stainless steel, aluminum, glassy carbon, titanium, platinum, silver or anodized aluminum and wherein the ultrasonic transducer extracts [¹⁸F] fluoride from the target chamber cavity using steam.

A further embodiment of the present invention is wherein the temperature of the target chamber is at least 340° C.

The present invention also shows a method for the use of extracting an isotope from a cyclotron target, the use of extracting an isotope from a cyclotron target, and the use of a gas target for extracting an isotope from a gas. The present invention further shows the use of extracting an isotope from a cyclotron target as well as the use of a gas target for extracting an isotope from a gas.

### EXAMPLES

The invention is further described in the following examples which is in no way intended to limit the scope of the invention.

### Examples

### Experimental Studies

I. Process Flow

For the two stage process the target is first filled with ¹⁸O₂ and bombarded with 19 MeV protons. The ¹⁸O₂ is then cryogenically recovered to leave [¹⁸F]fluoride bound to the target walls. The target is refilled with non-aqueous solvent such as acetonitrile, DMF, or DMSO. The ultrasonic transducer is then activated to re-suspended the [¹⁸F] fluoride in the non-aqeuous solvent, acetonitrile, DMF, or DMSO. The solution is then transferred from the target.

The automated steps in the process are described below.
1) At power on the rig will have all valves closed. It can either go into “manual mode for maintenance, or the normal automatic mode. Both target enable signals to the MC40 control system will be off.
2) The target selector valve connected to the selected target opens, and remains open throughout the process. The vacuum valve also opens to pump the selected target.
3) The target is pumped for 30 mins. During this period the alternative target can be selected, or the system stopped, or manual mode selected. At the end of this period the target is checked for vacuum (using the pressure transducer). If vacuum in not adequate then the PLC will issue a warning.
4) Unless the cell door is closed neither of the cryogenic dewer hoists can move. This is to prevent trap injuries to staff. Cell door closed is not available so 1^{st} shoot unload permissive will be used.
5) The cryo pump dewer is raised, to cool the gas in the main cryo vessel. A time delay is necessary to achieve thermal equilibrium.
6) The Valve closes to isolate the vacuum pump. Valves open and the cryo pump dewer is lowered. As the contents of the main cryo vessel warms the target is filled with ¹⁸O₂ until the required pressure is reached. Valves then close and the target is ready to bombard.
7) If the target fails to reach the required pressure then the cryo loop is used (in conjunction with valves) to increase the target pressure. With valve open gas is cryo pumped into the loop; then with valve open the loop returns to room temperature so increasing the target pressure.
8) Target ready signals are sent to the MC40 control system, allowing the target to be bombarded.
9) At the end of the bombardment, target unload is selected on the HMI. The target must not unload unless hot cell is ready. Target ready to the MC40 is cancelled.
10) The cryo pump dewer is raised and the main cryo vessel is cooled. The content of the target is then recovered by cryo pumping it back to the vessel, with valves open. It should be confirmed that a suitable vacuum exists.
11) Valves close to complete the 1^{st} shoot sequence.
12) A non-aqeuous solvent such as actonitrile, DMSO, or DMF are drawn into the syringe pump.
13) The target vent valve is opened and acetonitrile is pumped into the target cavity.
14) The target valves close to seal the target.
15) The Ultrasonic transducer is activated (period is set to obtain maximum extraction efficiency).
16) The target empty valve is opened and helium is used to transfer the radioactive solution to the required destination.
17) Steps 12-16 can be repeated if required.
18) The target is purged with helium (to vent) to dry the cavity.
19) The system then returns to standby mode.

### SPECIFIC EMBODIMENTS, CITATION OF REFERENCES

The present invention is not to be limited in scope by specific embodiments described herein. Indeed, various modifications of the inventions in addition to those described herein will become apparent to those skilled in the art from the foregoing description and accompanying figures. Such modifications are intended to fall within the scope of the appended claims.

Various publications and patent applications are cited herein, the disclosures of which are incorporated by reference in their entireties.

What is claimed is:

1. A method for the extraction of an isotope from a cyclotron target comprising the steps of:
i) Bombarding an amount of ¹⁸O₂ gas with protons within a gas target to separate an isotope;
ii) Recovering the ¹⁸O₂ gas from the gas target;
iii) Delivering a non-aqueous solvent into the gas target;
iv) Forming a suspension of said isotope of interest within said non-aqueous solvent within the gas target;
v) Transferring said suspension from said gas target to a second location; and
vi) Removing the solvent from said suspension at said second location.

2. The method of claim 1, wherein said isotope is ¹⁸F.

3. The method of claim 1, wherein said non-aqueous solvent is acetonitrile, DMSO, or DMF.

4. The method of claim 1, wherein said forming step further comprises the step of suspending said isotope into the non-aqueous solvent using an ultrasonic transducer.

5. The method of claim 4, wherein said ultrasonic transducer is located within said gas target.

6. The method of claim 1, further comprising the step of flushing residual solvent from said gas target.

7. A gas target for extracting an isotope from a gas wherein the gas target comprises a temperature sensitive target chamber material, an ultrasonic transducer, a target chamber cavity, a target vent port, a target empty port, a connection cable attaching the ultrasonic transducer to a delivery system, a water jacket, and a target fill port.

8. The gas target according to claim 7, wherein the water jacket is used to keep the gas target from overheating.

9. The gas target according to claim 7, wherein the target fill port is the port where the non-aqueous solvent is administered.

10. The gas target according to claim 7, wherein the chamber material is nickel-plated aluminum, stainless steel, aluminum, glassy carbon, titanium, platinum, silver or anodized aluminum.

11. The gas target according to claim 7, wherein the ultrasonic transducer extracts [¹⁸F] fluoride from the target chamber cavity using steam.

12. The gas target according to claim 7, wherein the temperature of the target chamber is at least 340° C.

13. The method for the use of extracting an isotope from a cyclotron target according to claim 1.

14. The use of extracting an isotope from a cyclotron target according to claim 1.

15. The use of a gas target for extracting an isotope from a gas according to claim 8.
